(19) United States
(12) Patent Application Publication
(10) Pub. No.: US 2014/0061270 A1
(43) Pub. Date: Mar. 6, 2014

(54) APPARATUS SUPPORT CONSOLE FOR MOBILE TELEPHONES OR SIMILAR APPARATUS ON THE HANDLE BAR OF BIKES

(71) Applicant: Harald Richter, Engelsbrand (DE)

(72) Inventor: Harald Richter, Engelsbrand (DE)

(21) Appl. No.: 14/011,457

(22) Filed: Aug. 27, 2013

(30) Foreign Application Priority Data
Aug. 29, 2012 (DE) 10 2012 017 056.4

(51) Int. Cl. B62J 11/00

(52) U.S. Cl. CPC B62J 11/00
USPC 224/420

(57) ABSTRACT

In an apparatus support console for supporting mobile phones and similar electronic apparatus in the area of the handlebar of a bicycle, comprising a front end part, a middle part and a rear end part, the front end part is adapted to support an apparatus holder or an apparatus mounting plate or a connecting part for a mounting plate or is in the form of an apparatus holder, and the rear part is plate-shaped and adapted for mounting onto the upper end of fork shaft or steerer tube of a bicycle immediately above the connection of a handlebar stem to the fork shaft or steerer tube.

### BACKGROUND OF THE INVENTION

The invention resides in an apparatus support console for supporting and mounting support devices for mobile telephones, smart phones and similar electronic apparatus.

Such apparatus support consoles adapted to be mounted to the handlebars by means of clamping jaws or clamping sleeve elements are already known. They have generally the disadvantage that they support the mobile phone or other apparatus not in the center of the handlebar because the handlebar is mounted there to the handlebar shaft or the shaft forward extension. The apparatus is therefore generally arranged to the left or to the right of the center of the handlebar. This makes the use of the apparatus inconvenient, in particular if the apparatus is a smart phone used as a navigation apparatus since it is not in the center of the viewing area of the driver.

For a central mounting, only one apparatus support arrangement is known which is integrated into the front end of a particular stem part but which is not usable otherwise.

It is the object of the present invention to provide a universally useable apparatus carrier console for central installation on a bike handlebar arrangement including a forward projecting handlebar stem. Such a handlebar stem engages the fork shaft from without and is clamped thereto by screws.

### SUMMARY OF THE INVENTION

In an apparatus support console for supporting mobile phones and similar electronic apparatus in the area of the handlebar of a bicycle, comprising a front end part, a middle part and a rear end part, the front end part is adapted to support an apparatus holder or an apparatus mounting plate or a connecting part for a mounting plate or is in the form of an apparatus holder, and the rear part is plate-shaped and adapted for mounting onto the upper end of a fork shaft or steerer tube of a bicycle immediately above the connection of handlebar stem to the fork shaft or steerer tube.

The front end mounting area for mounting an apparatus holder may be formed by elements which are adapted as necessary to the mounting of an apparatus holder, an adapter or another connecting arrangement.

The invention will become more readily apparent from the following description of an exemplary embodiment thereof with reference to the accompanying drawings.

### BRIEF DESCRIPTION OF THE DRAWINGS

FIG. 1 shows the apparatus support console according to the invention in a perspective view.

FIG. 2 shows the apparatus support console together with steerer components, which are shown in soft lines, and an apparatus support mounted thereon,

FIG. 3 shows in a perspective view the apparatus console according to FIG. 1 with spacer washers provided at the steerer end mounting area and an upper cover lid,

FIG. 4 is a side view of the arrangement shown in FIG. 3 and

FIG. 5 is a perspective bottom view of the arrangement shown in FIG. 3.

### DESCRIPTION OF AN EXEMPLARY EMBODIMENT

The exemplary embodiment shown in the figures is at the front mounting area thereof provided with a ball cap element for the articulated connection of on intermediate element for mounting an apparatus holder.

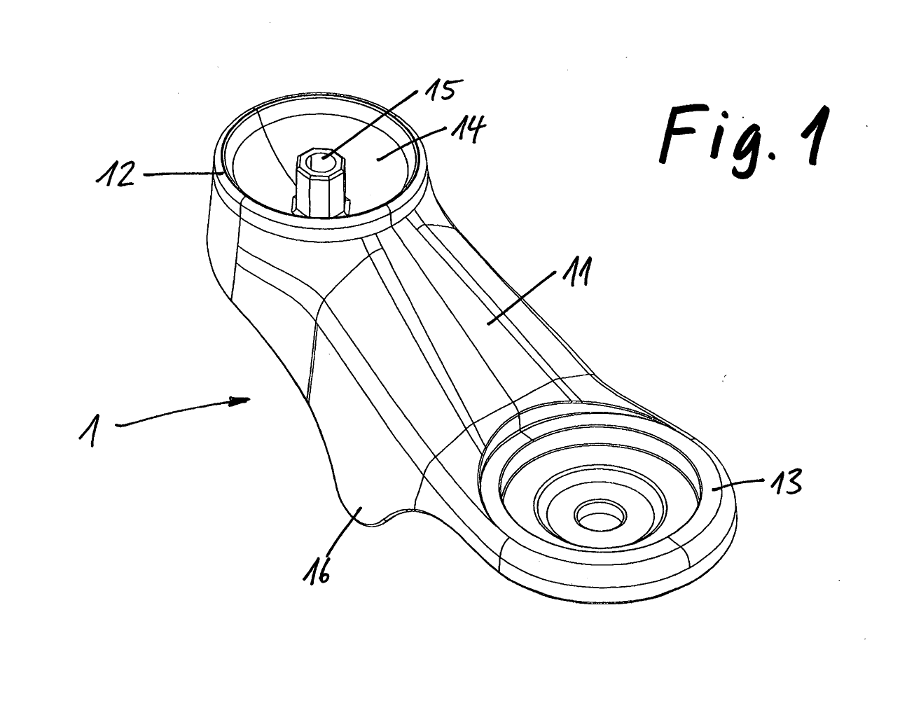

FIG. 1 shows the apparatus support console in the form of an elongated plate body 1 with a middle part 11, a front end part 12 and a rear end part 13.

The front end part 12 is formed so as to facilitate the mounting of an apparatus holder. In the exemplary embodiment, it is in the form of a ball cup element 14 and a central hollow multi-edged guide pin 15 for supporting, via a ball cup joint arrangement, a mounting plate for attaching an apparatus holder or for directly mounting an apparatus holder. This front end part however may also be formed in a different way if other arrangements for supporting an apparatus holder are to be provided.

The rear end part 13 is plate-like shaped and designed to be mounted onto the upper end of the tubular stem. The plate-like shape with a central bolt opening permits the insertion of a screw and the recessed arrangement of the screw head as well as the mounting of a lid covering the screw head.

The middle part of the apparatus support console 1 has at its opposite sides downwardly projecting legs 16 which may extend somewhat over the handlebar stem so as to provide side support so that the apparatus support console 1 is engaged via these legs 16 by the handlebar stem even if the screw which connects the rear end part 12 to the upper end of the stem quill 6 should loosen somewhat.

In addition, the middle part 11 of the apparatus support console is slightly inclined upwardly as shown in FIG. 1 so that the front end part 12 is disposed slightly higher than the rear end part 13.

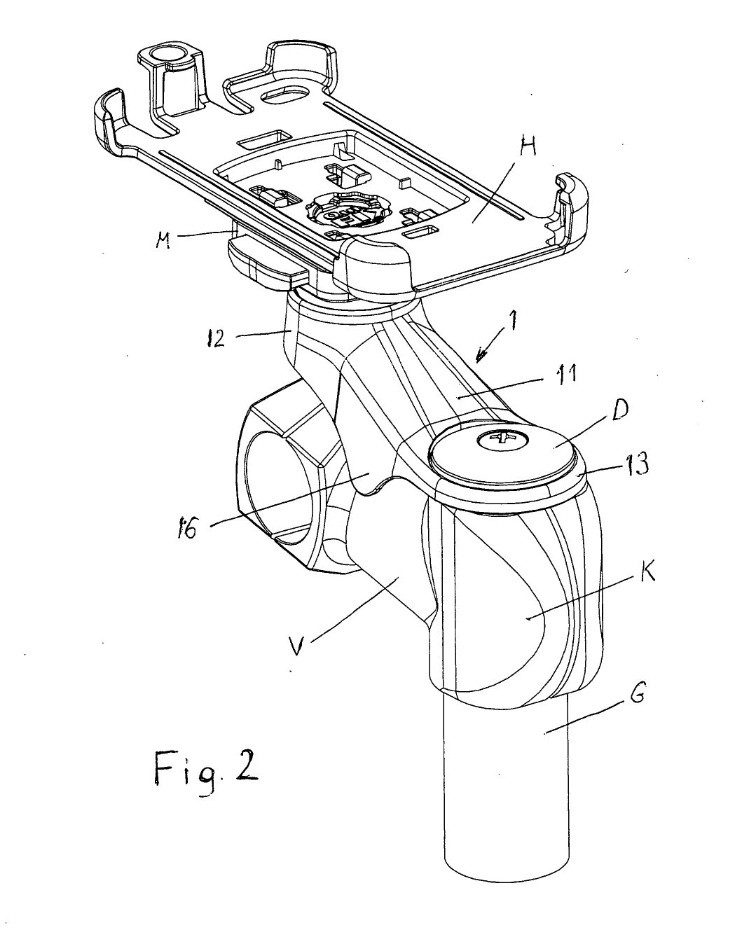

FIG. 2 shows the apparatus support console 1 mounted onto the steerer tube of a bicycle. The upper end of the steerer tube G and the stem V with its clamping connection at the upper end of the steerer tube G and a cover D which is disposed on the end part 13 and covers the screw for mounting the apparatus carrier console to the steerer tube as well as a support plate M which is mounted to the front end part of the apparatus support console and to which a support holder H for engaging a navigation apparatus, a mobile telephone or other device are shown in thin lines.

The support plate M is provided at its bottom site with a ball joint element which cooperates with the ball cap element 14 of the front end part 12 of the apparatus support console 1 so that the support plate M can be adjusted universally in all directions by a certain pivot range and can be locked in a desired position. The particulars of the universal joint which is formed by the ball cup element 14 including the multi-edged guide pin 15 and the corresponding counter elements on the support plate H are not subject of the present invention and, therefore, are not described in detail; they are known from EP 1 688 659 B1 or U.S. Pat. No. 7,241,069B2.

In order to mount the apparatus support console 1 at a level higher than as shown in FIG. 2, spacer washers A may be arranged between the upper and of the fork shaft tube G and the rear end part 13 of the apparatus support console 1. Such spacer washers may be provided in dimensions and may be installed individually or also together in combination sets so as to provide for the desired distance or a higher positioning of the apparatus support console.

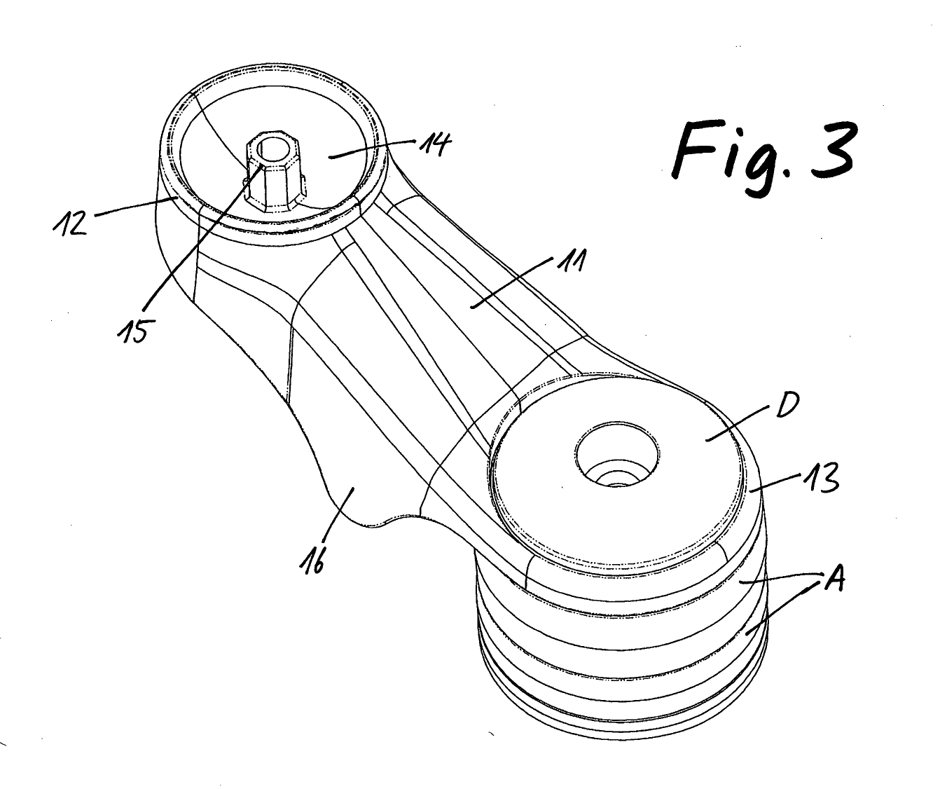

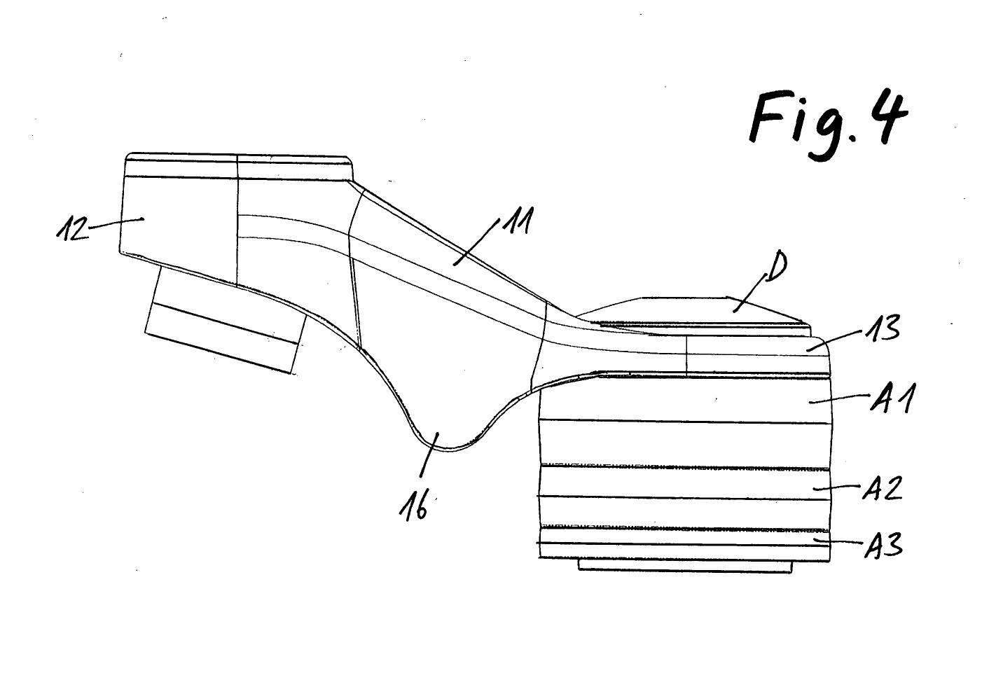

An apparatus support console 1 combined with such spacer washers A is shown in FIGS. 3-5. FIG. 3 shows a perspective view of the apparatus support console 1 similar to FIG. 1 wherein however the rear end part 13 is provided at its bottom with spacer washers A and the cover D is disposed on the rear end part 13 as also shown in FIG. 2. FIG. 4 shows this arrangement in a site view from which it is more clearly apparent that the distancing arrangement is provided by three spacer washers A1, A2 and A3 which are stacked on top of one another and, in the exemplary embodiment, have different axial thicknesses. Bu a suitable combination of such spacer washers, the desired height can be achieved in small steps using the needed amount and type of spacer washers.

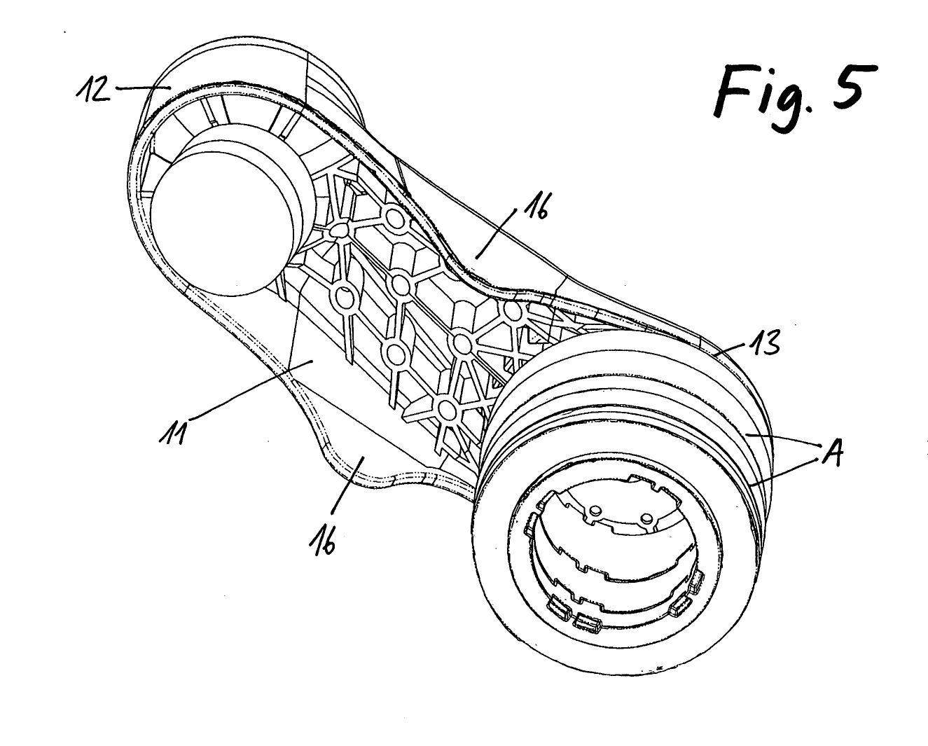

FIG. 5 shows a combination of the apparatus support console 1 with spacer washers in a perspective bottom view, in which the web reinforcement structure for plastic components at the bottom side of the middle part 11 of the elongated apparatus support console 1 is visible. Preferably, the apparatus support console 1 as well as the spacer washers A and the mounting plate M to be disposed on the apparatus support console 1 consist of a plastic material.

Instead of the spacer washers A as shown in FIGS. 3-5, it is of course also possible to use tubular distance pieces of different axial length below the plate-like rear end part 13. This would require an assortment of different length spacer tube pieces to be able to provide for each application an appropriate apparatus support console level but, of course, no spacer washers would be required. The provision of spacer washers which can be selectively installed as shown in the drawings is economically more efficient.

What is claimed is:

1. An apparatus carrier console for mounting mobile telephones and similar electronic apparatus in a handlebar area of bicycles, comprising:
an apparatus support console (1) with a front end part (12), a rear end part (13) and a middle part (11), the front end part (12) being designed for engaging an apparatus holder (H) or an apparatus mounting plate (M) or a connecting part for a mounting plate or an apparatus holder, or having such an apparatus holder integrally formed thereon and the rear part 13 being plate-like and adapted for mounting onto the upper end of a fork shaft tube of a bicycle immediately above a connection of a handlebar stem and the fork shaft tube.

2. The apparatus carrier console according to claim 1, wherein the rear plate-like end part (13) is provided with a center passage for accommodating a screw.

3. The apparatus carrier console according to claim 1, Wherein the rear plate-like end part 13 is formed for the recessed arrangement of the screw head of the screw extending through the screw passage and for the accommodation of a cover D covering the screw head.

4. The apparatus carrier console according to claim 1, wherein the on end part (12) is provided with a ball joint element (14) for connecting a mounting plate (M) of an apparatus holder H or an intermediate element so as to be tiltable in any direction for position adjustment of a an apparatus mounted on the apparatus holder.

5. The apparatus carrier console according to claim 4, wherein the ball element 14 is in the form of a ball cup element with a central hollow multi-cornered guide pin (15).

6. The apparatus carrier console according to claim 1, wherein the support console is plate-shaped.

7. The apparatus carrier console according to claim 1, wherein in the middle area (11) the console (1) is provided at both sides with downwardly projecting legs (16).

8. The apparatus carrier console according to claim 1, wherein spacer washers (A) of the same or different axial thicknesses are provided for placement between the bottom side of the plate-like rear end part (13) and the connection between the fork shaft and the handlebar stem.

9. The apparatus carrier console according to claim 1, wherein the plate-like rear end part (13) is provided with a spacer tube section extending from the bottom of the plate-like rear end part (13).
